(19) United States
(12) Patent Application Publication
(10) Pub. No.: US 2013/0032986 A1
(43) Pub. Date: Feb. 7, 2013

(54) Selectable Collect Folder and Folding Method

(71) Applicant: John Sheridan Richards, Barrington, NH (US)

(72) Inventor: John Sheridan Richards, Barrington, NH (US)

(73) Assignee: GOSS INTERNATIONAL AMERICAS, INC., Durham, NH (US)

(21) Appl. No.: 13/539,839

(22) Filed: Jul. 2, 2012

Related U.S. Application Data
(60) Provisional application No. 61/503,276, filed on Jun. 30, 2011.

(51) Int. Cl. B41F 13/62

(52) U.S. Cl. 270/21.1

(57) ABSTRACT

A printing press is provided. The printing press includes at least one printing unit for printing on a running web, a cutting cylinder for cutting the web into sheets and a folder for folding sheets cut from the web. The folder includes a collect cylinder for accumulating a number of sheets at a collect location, a folding cylinder for folding the accumulated number of sheets received from the collect location to form a folded section, a cam arrangement including a supplementary cam device for controlling the number of sheets collected on the collect cylinder and an actuator for actuating the supplementary cam device. Methods are also provided.

Priority is hereby claimed to U.S. Provisional Application No. 61/503,276 filed Jun. 30, 2011, and hereby incorporated by reference herein.

The present invention relates to printing presses and more particularly to folders in a printing press.

### BACKGROUND

Folders in a printing press may be operated to run in a “collect” mode in which the folder accumulates a predetermined number of products before passing the accumulated products along. Folders running in collect mode are often fed by multiple webs which were previously accumulated in page groupings from multiple printing groups, for example web offset printing units. The collect cylinder is typically arranged to selectively feed, for example, sheets in a two collect delivery, a three collect delivery, and so on. A two collect refers to a delivery of two sets of sheets at a time, and a three collect involves a delivery of three sets of sheets at a time. Alternatively, the folder may operate in a straight mode, in which the folder does not accumulate any products but rather delivers a set of single sheets at a time to a downstream operation.

Digital printing presses do not require the use of printing plates and thus have a quicker and less expensive turnaround time than traditional lithographic and flexographic printing presses. Further, digital printing presses can produce different images in successive revolutions if a digital print unit is being used including for example, direct imaging pages in an offset printing press. If another type of digital printer is being used, different images may be successively printed on the web as desired. When multiple sets of different pages are produced digitally and when multiple sets of pages with different subject matter can be selectably sequenced onto one web, the associated folders cannot accumulate or “collect” a varying number of products in the traditional manner. Consequently, the capabilities of a digital printing press would be greatly reduced when using traditional collect mode folders.

U.S. Publication No. 2007/0135286, hereby incorporated by reference herein, discloses a folder having a collect cylinder mounted for rotation and a collect cylinder drive mechanism for rotating the collect cylinder.

U.S. Pat. No. 4,381,106, hereby incorporated by reference herein, describes a known arrangement for a collect cylinder having a non-rotating cam and a rotating cam mask. A gripper for gripping a product is opened and closed by a cam follower that engages a cam surface of a fixed, non-rotating cam. The cam surface is profiled to coordinate the gripper opening and closing operations with the location of the gripper at product taking and product release stations respectively. A rotating mask has camming surfaces that selectively mask the surface profile of the cam, to thereby permit or prevent operation of the gripper, to provide a selected mode of operation.

U.S. Pat. No. 7,744,518, hereby incorporated by reference herein, discloses a folder that includes a device for cutting sheets from a web of paper, a folding cylinder provided with movable retention devices and movable blades for folding the sheets cut from the web, a cam for controlling the movement of the movable retention devices by contact with cam followers, a cam for controlling the movement of the tucking blades by contact with cam follower, and at least one covering cam. The covering cam includes two semi-cams which can each be moved radially between a retracted position and an extracted position, the covering cam being in a configuration for straight operation when the semi-cams are in a retracted position and in a configuration for collect operation when the semi-cams are in an extracted position.

### SUMMARY

The present invention provides a printing press including at least one printing unit for printing on a running web, a cutting cylinder for cutting the web into sheets and a folder for folding sheets cut from the web. The folder includes a collect cylinder for accumulating a number of sheets at a collect location, a folding cylinder for folding the accumulated number of sheets received from the collect location to form a folded section, a cam arrangement including a supplementary cam device for controlling the number of sheets collected on the collect cylinder and an actuator for actuating the supplementary cam device.

The present invention also provides a method of forming a printed product. The method includes the steps of printing a running web with at least one printing unit, cutting a web into sheets, collecting a number of sheets on a collect cylinder at a collect location, actuating a supplementary cam device to control the number of sheets collected at the collect location and folding the number of sheets received from the collect cylinder to form a section.

The present invention further provides a method of digitally printing a web and forming a printed product from the web. The method includes the steps of printing a web in a sequence with at least one digital printing unit, cutting the web into a plurality of sheets, collecting a first number of sheets on a collect cylinder at a first collect location, collecting a second number of sheets on the collect cylinder and changing the number of sheets collected from the first number to the second number while the web is running

The present invention applies folder technology to digital printed products approaching web offset speeds and exceeding speeds of sheeters, collators and buckle folders.

The present invention provides for the production of multi-page newspapers with a selectable number of pages from digitally printed sources.

The present invention provides an actuatable, selectable collect and folding cylinder. The present invention further provides a transfer cylinder.

In a typical collect folder, a cam mask rotates in the collect mode to selectively determine which collected groups of products are complete and are therefore ready to fold off into the jaw. In the present folder, a supplementary cam device is moved into position by an actuator, so the number of products to be collected before folding off is selectable to match the number of digitally printed pages that have been printed, which can vary from job to job, version to version or copy to copy.

Conventional folders do not include a transfer cylinder. Including a transfer cylinder eliminates the creation of “macaroni.” Macaroni, as known in the art, are slivers of paper resulting from a new cut made adjacent to one or more already collected products, thereby severing the previously collected products. In accordance with the present invention, the cutting cylinder cuts the web into printed products against the transfer cylinder, the transfer cylinder then transfers each individual product to the collect cylinder after the printed product has been cut, thus, there are no previously cut pages at the point of cutting a new sheet. As a result, the collect cylinder does not serve as a counter cylinder to the cutting cylinder, the collect cylinder simply collects printed products already cut from the web.

### BRIEF DESCRIPTION OF THE DRAWINGS

A preferred embodiment of the present invention is described below by reference to the following drawings, in which:

FIG. 1 shows a printing press having a folder according to the present invention;

FIG. 2 shows a panorama sheet printed by the printing press shown in FIG. 1;

FIGS. 3A and 3B show the folder of FIG. 1 including a cam mask in accordance with a preferred embodiment of the present invention;

FIGS. 4A and 4B show the folder of FIG. 1 including a cam follower clamp rod in accordance with another preferred embodiment of the present invention;

FIGS. 5A and 5B show the folder of FIG. 1 including a second cam in accordance with a further preferred embodiment of the present invention;

FIGS. 6 and 7 show images printed on a web and sheets collected on a collect cylinder to form a section in accordance with a preferred embodiment of the present invention;

FIGS. 8 and 9 show images printed on a web and sheets collected on a collect cylinder to form two sections in accordance with a preferred embodiment of the present invention;

FIGS. 10 and 11 show images printed on a web and sheets collected on a collect cylinder to form a complete newspaper in accordance with a preferred embodiment of the present invention;

FIG. 12 shows a preferred embodiment of a folder operating in folding mode according to the present invention; and

FIG. 13 shows the folder arrangement of FIG. 12 running in two collect mode.

### DESCRIPTION OF THE DRAWINGS

A printing press according to the present invention is configured to produce printed products such as newspapers, for example, tabloid or broadsheet newspapers, from a web containing pages printed sequentially on a single web. The pages are printed in a sequence needed to produce the desired final product or newspaper. The printed products and newspapers may include a plurality of sections. The number of sections per newspaper and the number of pages in each section are fully variable in accordance with a preferred embodiment of the present invention.

Broadsheet newspapers printed on a digital printing press are produced with the newspaper columns laid out across the length of a web, along the direction of web travel. The vertical spine of the broadsheet newspaper is produced in a folder, for example, a jaw folder, by a fold extending across the web. Other types of folders may also be used. The horizontal fold across the middle of the height of the broadsheet newspaper is made parallel with the direction of web and product travel. The second fold may be produced by a further folder, for example, a quarter folder or chopper. Tabloid newspapers printed on a digital printing press are also produced with the newspaper pages laid out across the length of the web, along the direction of web travel. The vertical spine of the tabloid newspaper is produced in a folder, for example, a jaw folder, by a fold extending across the web. As known in the art, tabloid newspapers usually include only one fold, the vertical spine. Other types of folders may also be used.

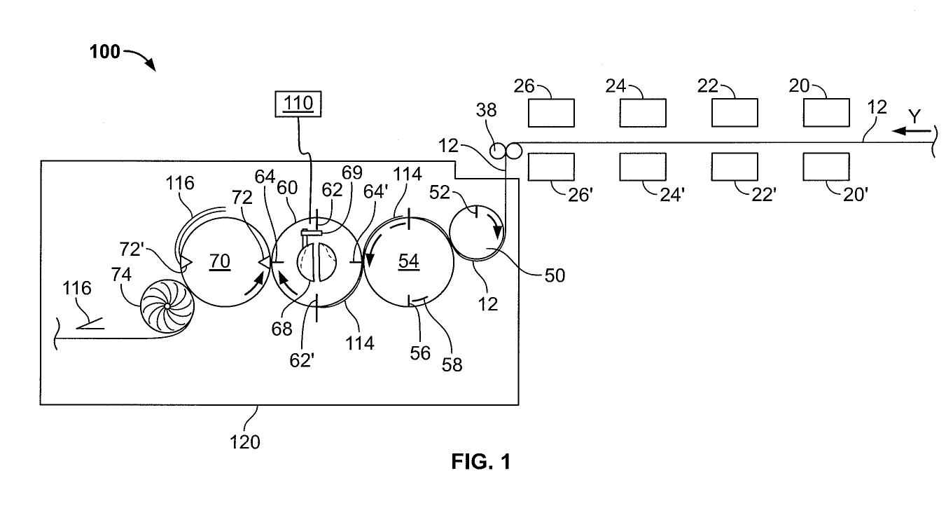

FIG. 1 shows a printing press 100 including a folder 120 in accordance with the present invention. Printing press 100 includes a plurality of printing units 20, 20′, 22, 22′ 24, 24′, 26, 26′. Printing units may be, for example, digital print units, including direct imaging print units, ink jet printers or laser printers. Printing press 100 may be an offset press or digital print engines may print directly on the web. Preferably, press 100 includes digital print engines 20, 20′ 22, 22′, 24, 24′, 26, 26′ located on either side of web 12 for printing on both sides of web 12 as web 12 travels in a direction Y. The number of digital print engines used may vary as desired.

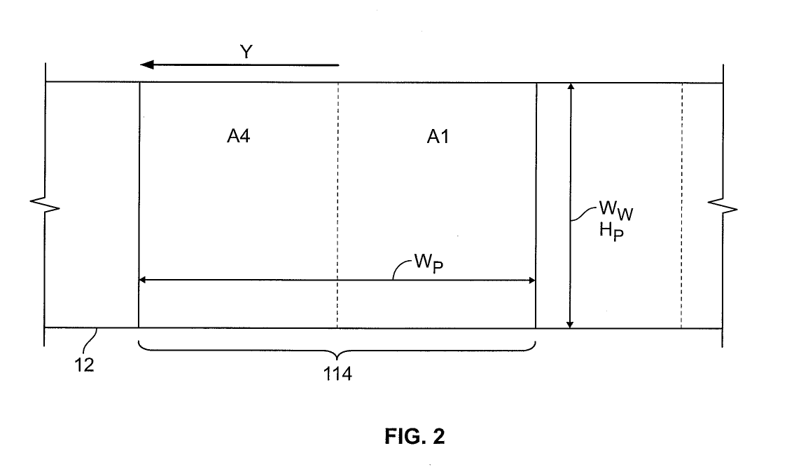

As discussed above, sheets are printed with images printed along the length of web 12, in the direction of web travel Y, thereby producing a panorama sheet 114. (See FIG. 2). As a result, panorama sheet 114 has a height H_{P} equal to a width of web 12 (W_{W}) and a width (W_{P}) which is two pages wide. Pages are identified as A1 and A4. The other side panorama sheet 114 includes pages A2 and A3, respectively. In another embodiment, the web may have a web width that is wider than a height of the panorama sheets thereby accommodating multiple rows of panorama sheets. For example, a double wide web (W_{2W}) would be equal to 2H_{P} and accommodate the printing of two rows panorama sheets across the web.

Digital print engines may print pages of a desired final product in a sequence on the web so final products may be made on a copy per copy basis in contrast to traditional offset printing methods in which a section or portion of a final product is made in multiples and the different sections are later combined with each other. For example, when printing a newspaper, each page of the newspaper may be digitally printed on the web before the digital print engines start printing a second copy or version of the newspaper, thereby forming one complete newspaper from sequential images on the web. The digital print engines can begin printing the second newspaper without stopping the press to change folder modes. In addition, if, for example, newspaper sections are desired, an entire first section may be digitally printed on the web in sequence before second, third and further successive sections begin printing, regardless of the number of pages in the different sections. In another alternative, different sections may be printed in a desired sequence and formed simultaneously, regardless of the number of pages desired in each section. Thus, different sections can be digitally printed at any time and in any order as desired by the press operator. Further flexibility provided by the digital print engines also provides for different sections to be printed in duplicates or multiples as desired. For example, a first newspaper section A, may be collected at each gripping location on a collect cylinder and folded off into a jaw cylinder. A second newspaper section B may then be collected at each gripping location and folded into the jaw cylinder. Successive printing of section A and section B can occur without stopping the press regardless of the number of sheets collected in each section.

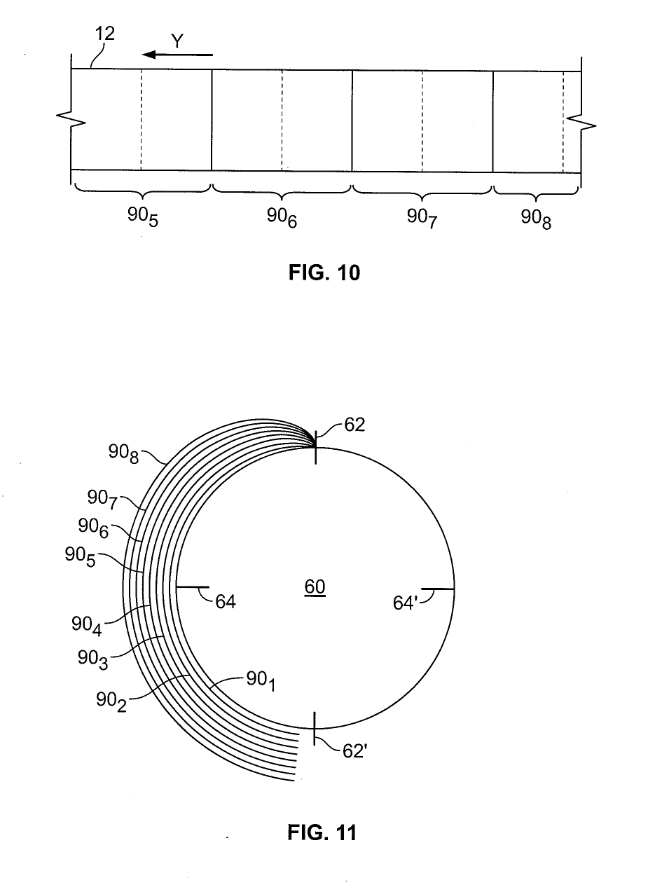

Web 12 enters folder 120 and is cut into sheets or printed products by a cutting cylinder 50 having cutting blades 52. Folder 120 includes a one-around cutting cylinder 50, as known in the art, one around cylinder has circumference which supports a single sheet 114. Folder 120 also includes a two around transfer cylinder 54, a two around collect cylinder 60, a two around jaw cylinder 70 and a fan wheel 74. Other embodiments and configurations of folder 120 are also possible and will be described below with respect to FIGS. 10 and 11. A controller 110 may be provided to control components of folder 120 and/or press 100.

Cutting cylinder 50 works in conjunction with a transfer cylinder 54. Transfer cylinder 54 includes two pins 56 and two cutting rubbers 58. Pins 56 grip a lead edge of a new sheet to be cut from web 12. Pins 56 may be any form of sheet gripping device for example, pins, mechanical grippers or vacuum grippers. Cutting blade 52 extends and cuts web 12 into sheets 114 against the surface of transfer cylinder 54. Cutting rubber 58 serves as a counteracting surface for cutting blade 52.

Sheets 114 are then transferred to collect cylinder 60. Collect cylinder 60 includes two pins 62, which may also be any type of sheet gripping device, for example, pins or mechanical grippers and two tucking blades 64 for folding off sheet(s) 114. Both pins 62 and tucking blades 64 are controlled by cam arrangements. Jaw cylinder 70 includes two jaws 72 for receiving sheets from collect cylinder 60. Tucking blades 64 tuck sheets 114 into jaws 72 of jaw cylinder 70.

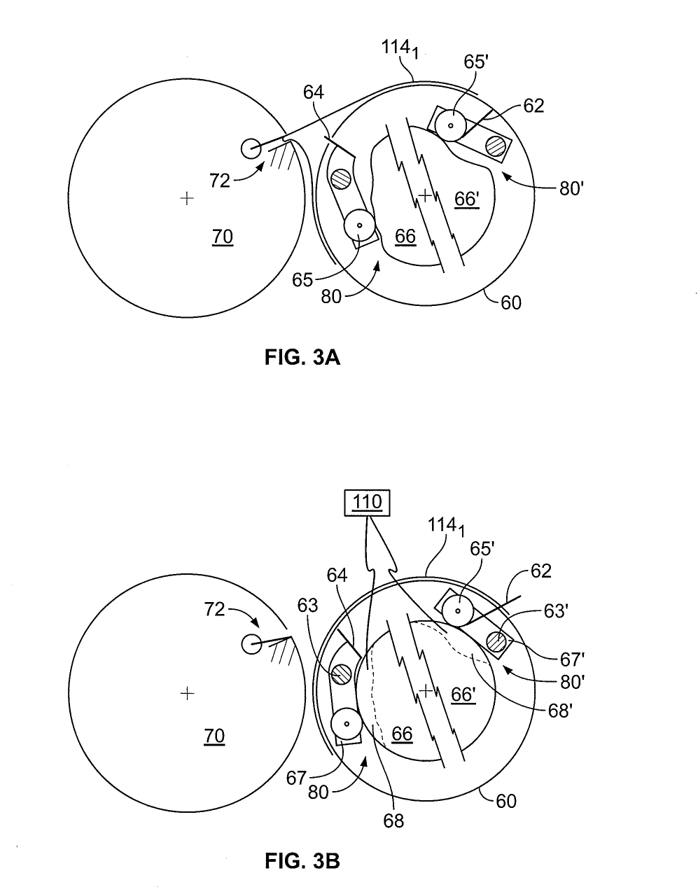

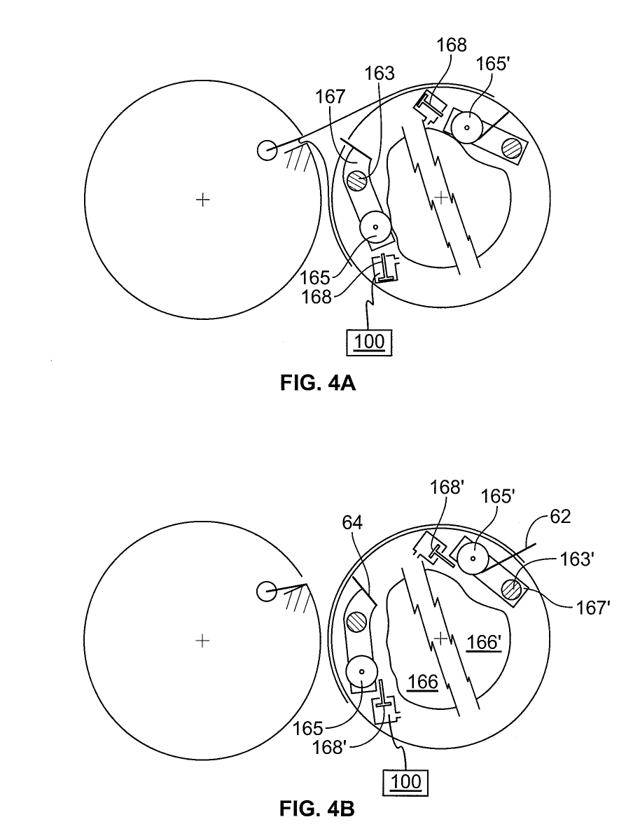

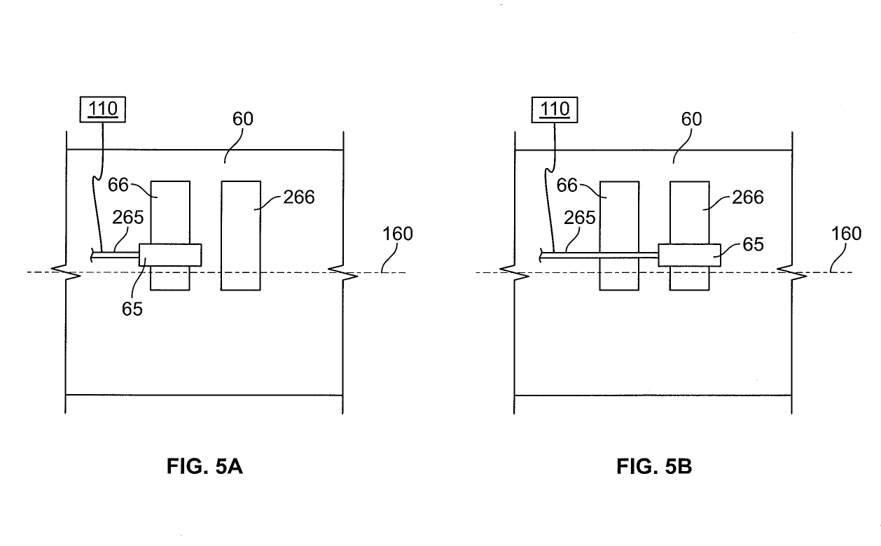

In accordance with a feature of the present invention, collect cylinder 60 includes actuatable cam arrangements 80 (See FIGS. 3A to 5B) for each tucking blade 64, 64′ and cam arrangements 80′ for each pin 62, 62′. Each cam arrangement 80, 80′ includes a cam 66 and a cam follower 65. The cam arrangements 80, 80′ also include a supplementary cam device, for example, a cam mask 68 shown in FIGS. 3A and 3B, a cam clamp 168, 168′ shown in FIGS. 4A and 4B and a second cam 266 shown in FIGS. 5A and 5B. The supplementary cam device works to inhibit cam follower 65 from following cam 66 in order to change the operating mode of collect cylinder 60 from running in a straight or folding mode to running in a collect mode as desired. By providing the cam arrangements 80, 80′ with a supplementary cam device, the operating mode of the collect cylinder can be changed quickly and easily, for example, on a copy by copy basis, thus allowing the folder to produce a single version of final printed product as opposed to producing a plurality of identical copies which form a section or partial production and need to be combined with other partial products to form a final printed product.

As shown in FIGS. 3A and 3B, both pin 62 and tucking blade 64 are actuatable via cam arrangements 80′, 80, respectively. FIG. 3A shows collect cylinder 60 and jaw cylinder 70 running in a folding mode during which sheets 114 collected on collect cylinder 60 are folded and tucked into jaws 72 on jaw cylinder 70. Folding mode may include straight mode operation in which each sheet 114 is tucked or folded into jaw cylinder 70. Folding mode also occurs after a desired number of sheets 114 are collected at pin 62 and folded off into jaw 72 together.

FIG. 3A shows pin 62 and tucking blade 64 just after tucking a sheet 114 into jaw 72. A tucking blade cam arrangement 80 actuates tucking blade 64 and a pin cam arrangement 80′ actuates pin 62. The tucking blade cam arrangement 80 includes a cam follower 65 which follows along the profile of cam 66 as collect cylinder 60 rotates. The motion of cam follower 65 along the profile of cam 66 actuates tucking blade 64 to tuck collected sheets 114 into jaw 72 of jaw cylinder 40. Tucking blade 64 extends into jaw 72 in order to tuck sheets 114 into jaw 72, then 64 retracts within the circumference of collect cylinder 60. (See FIG. 3B). Similarly, pin cam arrangement 80′ includes a cam follower 65′ following the profile of a cam follower 66′. Pin 62 is actuated to release sheets 114 from collect cylinder 60 as sheets 114 are folded off or tucked into jaw cylinder 70. Upon folding or tucking, pin 62 retracts to a position within the circumference of collect cylinder 60 thereby releasing the collected sheets 114.

FIG. 3B shows collect cylinder 60 and jaw cylinder 70 running in a collect mode. During collect mode, sheets 114_{N} are collected along the circumference of collect cylinder 60 at pins 62 until the desired number of sheets 114_{N} is reached at each pin 62. As shown in FIG. 3B a single sheet 114₁ is collected at pin 62. Cylinder 60 is rotating around to collect a second sheet 114₃ at pin 62. (See FIG. 7). Then, collected sheets 114₁, 114₃ are transferred to jaw cylinder 70 together and form a folded product or section 116 (FIG. 1).

In order for the cylinders to operate in collect mode, each tucking blade 64, 64′ and each pin 62, 62′ must be inhibited from releasing and tucking the collected sheets 114_{N}. In a preferred embodiment, each cam arrangement 80, 80′ includes a supplementary, actuatable cam device. In this embodiment, actuatable cam masks 68, 68′ are used to cover fixed cams 66, 66′ respectively, thereby changing the paths of cam followers 65, 65′. The profile of cam masks 68, 68′, subsequently inhibits the tucking blade 64 and pin 62 from tucking and releasing sheets. As shown in FIG. 3B, cam masks 68, 68′ are moved into a position which changes the profile followed by cam followers 65, 65′. For example, the low dwell area of cam profiles 66, 66′ are no longer followed by followers 65, 65′. Cam followers 65, 65′ are forced to follow the profile of cam mask 68, 68′ which is designed in such a way to prevent tucking blade 64 from extending into jaw 72 and prevent pin 62 from releasing sheet 114₁. As a result, pin 62 continues to hold and collect sheets 114 along the circumference of collect cylinder 60. Cam followers 65, 65′are attached to a bracket 67, 67′ and rotatable about pin 63, 63′.

An actuator, for example, pneumatic cylinder 69 is connected to controller 110 and cam masks 68, 68′. Each mask 68, 68′ may have a corresponding actuator connected thereto and to controller 110. When desired, pneumatic cylinder 69 (FIG. 1) actuates cam masks 68, 68′ to operate collect cylinder 60 in two collect mode (FIG. 3B). In this example, each pin 62, 62′ on collect cylinder 60 receives a sheet 114 from transfer cylinder 54. Transfer cylinder 54 subsequently delivers a second sheet 114′ to each pin 62 on collect cylinder 60 as both cylinders 54, 60 continue to rotate. Once collect cylinder 60 has received the desired amount of sheets 114, 114′ the sheets are tucked into jaw folder 70 forming folded sections 116. Folded sections 116 are subsequently delivered to a fan wheel 74 for further transport downstream. The controller 110 may use stored data, for example, input by a press operator, to control the cam arrangements 80, 80′ and supplementary cam devices. The stored data may include the number of pages printed on web 12 and the number of sheets in a section being formed on collect cylinder 60.

In a typical collect folder, cam mask 68 rotates in the collect mode until products are complete and are therefore ready to fold off into the jaw. The number of collected products is set, for example, two collect mode, three collect mode, etc. and does not change between copies. In accordance with a preferred embodiment of the present invention, cam mask 68 is moved into position by an actuator, for example, pneumatic cylinder 69, so that the number of sheets 114 collected before folding is selectable to match the number of digitally printed pages printed on web 12. The actuator may be pneumatic, hydraulic or servo driven, for example. The number of digitally printed pages may vary from job to job or copy to copy. By providing a supplementary cam device and actuator, faster and more flexible changes to the operating mode of the folder and collect cylinder, and number of sheets being collected are possible. Thus, a first section being formed may include 8 pages while a second section being formed may include 4 pages.

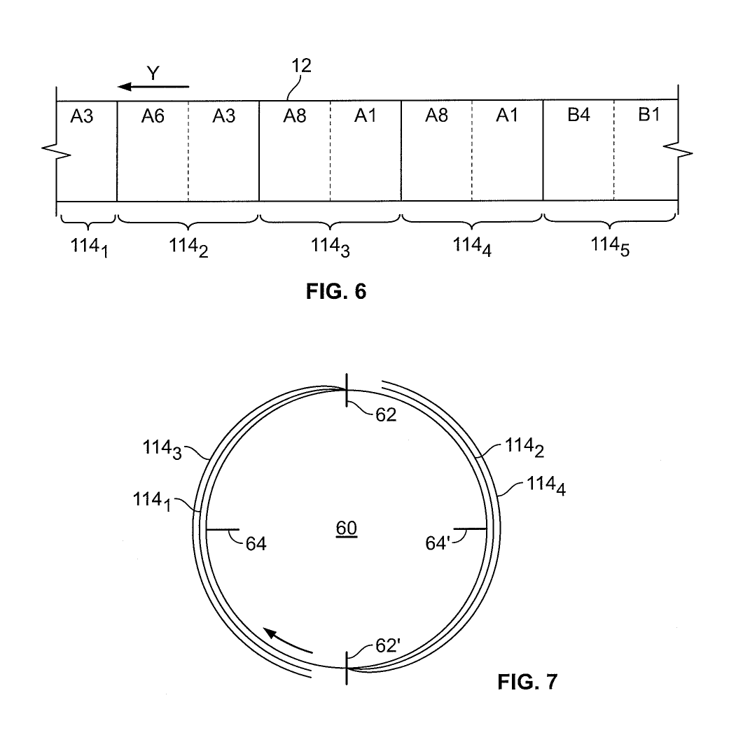

FIGS. 6 and 7 show a preferred embodiment in which the same section is collected at each collect location on the collect cylinder. FIG. 6 shows how panorama sheets 114_{N} are printed in a sequence across web 12 in the direction of web travel Y. In accordance with the two around collect cylinder 60 shown in FIGS. 1 and 7, each pin 62, 62′ simultaneously collects an identical section, section A, thereby producing and folding off two copies of section A into jaw cylinder 70. Section A includes two panorama sheets 114_{N} and will have a total of 8 pages. As shown on collect cylinder 60, a panorama sheet 114₁ including pages A3 to A6 is collected at pin 62. An identical panorama sheet 114₂ is collected at pin 62′. A second panorama sheet 114₃ including pages A1, A2, A7 and A8 is collected on top of panorama sheet 114₁ at pin 62. A second panorama sheet 114₄ identical to sheet 114₃ is collected on top of panorama sheet 114₂ at pin 62′. Thus, a section A will be formed from sheets 114₁, 114₃ collected at pin 62 and an identical, second section A will be formed from sheets 114₂, 114₄, collected at pin 62′. As shown on web 12 in FIG. 6, the next panorama sheet 114₅ includes pages B1 to B4 for the next sections, sections B, to be formed on collect cylinder 60.

Cam arrangements 80, 80′ and supplementary cam devices (shown in FIGS. 3A to 5B) are actuated to control the number of sheets 114_{N} collected at pins 62, 62′ before folding sheets 114_{N} to form sections A. The cam arrangements 80, 80′ and supplementary cam devices are then actuated to collect and release subsequent sections B as desired.

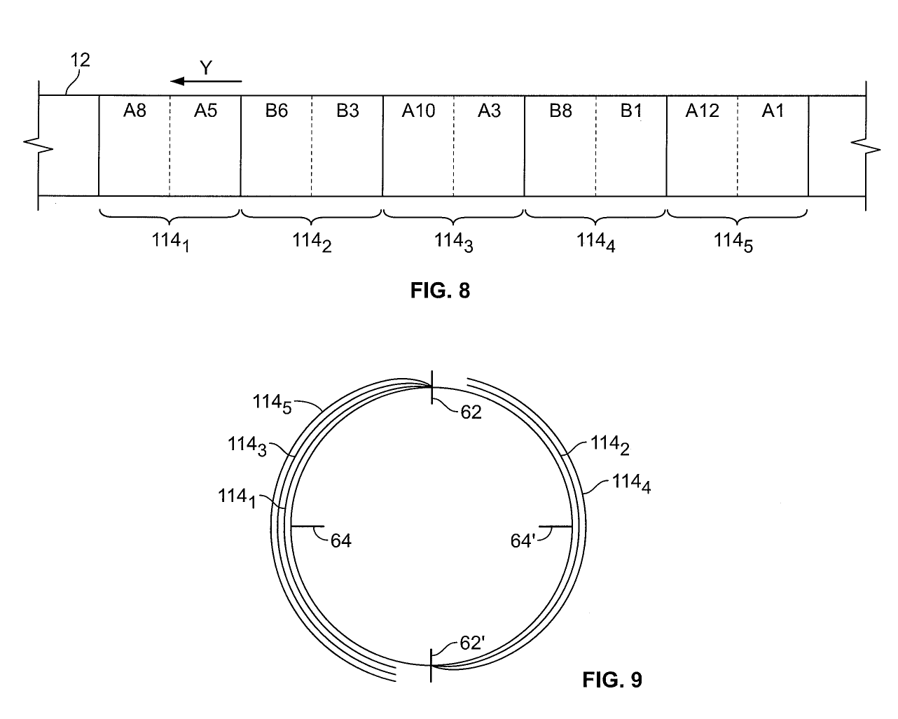

FIGS. 8 and 9 show another preferred embodiment in which the collect cylinder simultaneously collects two different sections, each section having a different number of pages. As shown in FIG. 8, images for both sections, section A and section B, are printed in a sequence across web 12 in the direction of web travel Y. In this embodiment, panorama sheets 114_{N} for both sections A, B are printed in an alternating manner. A first section, section A, is collected at pin 62 and includes three panorama sheets 114₁, 114₃, 114₅ resulting in a section A having a total of 12 pages, pages A1 to A12. A second section, section B, is collected at pin 62′ and includes two panorama sheets 114₂, 114₄ resulting in a section B having a total of 8 pages, pages B1 to B8.

Cam arrangements 80, 80′ and supplementary cam devices for pin 62′are actuated to release and fold off sheets 114₂, 114₄ into jaw 72′ once both sheets are collected at pin 62′ to form a section 116_{B}. (See FIG. 1). Cam arrangements 80, 80′ and supplementary cam devices for pin 62 are actuated to continue to collect a third sheet 114₅ on top of section sheet 114₃ at pin 62 prior to releasing and folding off sheets 114₁, 114₃ and 114₅ to form a section 116_{A}. The cam arrangements 80, 80′ are set to tuck, not tuck, release or collect as needed. Controller 110 may control the actuators and actuation of cam arrangements 80, 80′ and supplementary cam devices.

FIGS. 10 and 11 show a further preferred embodiment in which the collect cylinder 60 collects a single printed product, for example, a newspaper, at each collect location. Newspaper panorama sheets 90_{N} are printed on web 12 along the direction of web travel Y. Sheets 90_{N} are collected together until the final number of sheets is collected at each pin 62, 62′. In the example show in FIGS. 10 and 11, the newspaper includes eight sheets 90_{1 to 8} thereby forming a newspaper having a total of 32 pages. Tucking blade 64 tucks the eight sheets 90_{1 to 8} into a jaw 72 of jaw folder 70 thereby forming a 32 page product ready for delivery or further processing. FIG. 11 omits the sheets collected on pin 62′ for simplicity.

In accordance with another feature of the present invention, a transfer cylinder is provided. Transfer cylinder 54 advantageously eliminates double cuts and slivers in sheets 114 also known in the art as “macaroni.” In conventional folders, sheets 114 are cut directly on the collect cylinder. Thus, a pin is gripping the lead edge of one previously cut sheet and the lead edge of a second soon-to-be cut sheet. The cutting cylinder then makes a new cut in order to cut the second sheet against the collect cylinder, often times cutting an edge of the first sheet again. This second cut on the first sheet is undesirable. As a result, providing a transfer cylinder 54 for cutting each sheet 114, prior to collecting the sheets 114 on collect cylinder 60 prevents any double cuts or “macaroni.”

In another preferred embodiment, shown in FIGS. 4A and 4B, the supplementary cam device includes a cam follower clamp rod 168, 168′ which may be used in place of cam masks 68, 68′, respectively. In this embodiment, cam follower clamp rod 168, 168′extends to (FIG. 4B) to prevent cam followers 165, 165′ from following cams 166, 166′. Cam follower clamp rods 168, 168′ extend to support and hold brackets 167, 167′ at a distance from cams 166, 166′ so followers 165, 165′ do not contact the profile of cams 166, 166′ thereby preventing the movement of tucking blades 64 and pins 62. Clamp rods 168, 168′ may act as a clamp or barrier to prevent brackets 167, 167′from rotating or pivoting about pins 163, 163′. Cam follower clamp rods 168, 168′ may be connected to controller 110 and an actuator for movement into and out of engagement with brackets 167, 167′.

In a further preferred embodiment shown in FIGS. 5A and 5B, the supplementary cam device is a second set of cams 266 arranged along a length of a collect cylinder axis 160. The second set of cams 266 includes different profile geometry than cams 66 and may include profile geometry similar to that of cam mask 68. Thus, second cams 266 are utilized when collect cylinder is operating in collect mode. The cam arrangements are designed to be movable between cams 66 and second cams 266 as desired. FIG. 5A shows the cam follower 65 interacting with cam 66 and FIG. 5B shows cam follower 65 interacting with second cam 266. The cams followers 65 may be moved via actuatable rods 265 which are connected to controller 110 and an actuator. Brackets 67 and pins 63 of the cam arrangements have been omitted from the figure, but may be used to support cam follower 65.

In each of the previously described embodiments, a controller 110 may be used to automatically control the supplemental cam devices and actuators. For example, in FIGS. 3A and 3B, a controller 110 may be connected to the cam actuator, for example, the pneumatic cylinder 69, so the controller can actuate or de-actuate pneumatic cylinder 69 and cam masks 68, 68′. (See FIG. 1). In FIGS. 4A and 4B, the cam follower clamp rods 168, 168′ may be connected to a controller to control and actuate the intended movements and in FIGS. 5A and 5B, the actuatable rods 265 may also be connected to a controller in order to control and actuate the intended movements.

By providing selectably, actuatable cam arrangements, supplementary cam devices and actuators much higher folder speeds can be reached than with newspaper production equipment utilizing sheet accumulation and buckle folding principles. The higher speeds yield greater outputs, especially when combined with high speed digital printing presses. The actuatable cam arrangements when used in conjunction with a digital printing press provide folder flexibility. Folders may be switched from collect mode to straight mode on a per copy or per product basis.

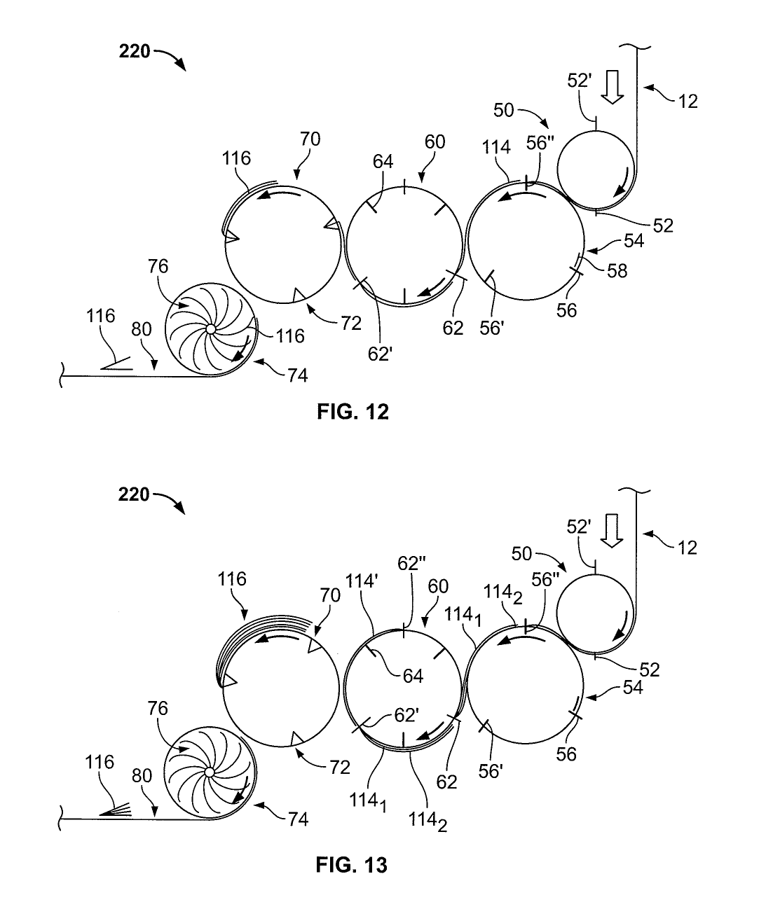

FIG. 1 includes a one around cutting cylinder 50 and two around transfer cylinder 54, two around collect cylinder 60 and two around jaw cylinder 20. However, other folder developments (e.g. sheets, grippers, jaws around the cylinders) including various cylinder sizes may be used in accordance with other preferred embodiments of the present invention. For example, another preferred embodiment of folder 220 in shown in FIGS. 12 and 13 includes a two around cutting cylinder 50, three around transfer cylinder 54, three around collect cylinder 60 and three around jaw cylinder 70. The same reference numerals used in FIG. 1 are used to identify the same components in FIGS. 12 and 13.

FIGS. 12 and 13 show a folder arrangement in accordance with the present invention. FIG. 12 shows folder 220 operating in a straight or folding mode in which each sheet 114 is cut from web 12, collected at a pin 62 and folded into a jaw 72 forming a folded sheet or section 116. The sections 116 are then transported to a delivery 80 via fan wheel 74. FIG. 13 shows collect cylinder 60 operating in two collect mode in which a first sheet 114₁ is collected at each pin 62, 62′, 62″, the first sheet 114₁ stays on collect cylinder 60 and a second sheet 114₂ is collected at each pin 62, 62′, 62″ on top of first sheet 114₁. Both sheets 114₁, 114₂ are folded off together into a jaw 72 of jaw folder 70 via a tucking blade 64 of collect cylinder 60 to form a product or section 116.

As shown in FIG. 13, pin 62′ is gripping first sheet 114₁ and second sheet 114₂, both sheets will be transferred to jaw cylinder 70 together to form a folded section 116. First sheet 114₁ at pin 62″ is cycling around collect cylinder 60 again so pin 62″ can collect a second sheet 114₂ from transfer cylinder 54. A lead edge of second sheet 114₂ is pinned at 56″ on transfer cylinder 64. Second sheet 114₂ is about to be cut from web 12 by cutting cylinder 50. Pin 62 on collect cylinder 60 is receiving a first sheet 114₁ from transfer cylinder 54, the lead edge of which was just released from pin 56′.

After sheets 114₁, 114₂ are combined at pins 62, 62′ 62″ the sheets 114₁, 114₂ are transferred to jaw cylinder 70 and subsequently to fan 74 wheel. Fan 74 includes a plurality of fan blades 76. A folded collection of sheets or section 116 is received between each fan blade 76. Fan 74 then deposits printed products 116 in a delivery stream 80 for further processing. Each pin 62, 62′, 62″ may be collecting sheets having different images thereby forming three different sections 116. However, as desired, each pin 62, 62′, 62″ may be collecting identical sheets 114₁, 114₂, thereby producing three identical sections 116.

When a single sheet 114 is collected, the resulting folded sheet or section 116 includes four pages. (FIG. 2). When folder 220 operates in two collect mode, and two sheets 114₁, 114₂ are collected, the resulting section 116 includes 8 pages. Larger folded products or newspapers may be produced by collecting further sheets, for example, three collected sheets provides 12 pages, four collected sheets provides 16 pages and 16 collected sheets provides 64 pages. Thus, products, such as newspaper sections, with a large number of pages may be formed as desired.

Other preferred embodiments of the present invention may include, printing and forming consecutive newspaper sections on the web and in the folder to form a single copy directly off folder, the sections may have the same page counts or different page counts. Sections produced from folder 120 may be subsequently accumulated in a post-fold accumulator to form a multi-section printed product that is wrapped or quarterfolded. Each section or folded printed product may also be stitched after the section has accumulated all of the desired number of pages.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A printing press comprising:
at least one printing unit for printing on a running web;
a cutting cylinder for cutting the web into sheets; and
a folder for folding sheets cut from the web, the folder including:
a collect cylinder for accumulating a number of sheets at a collect location;
a folding cylinder for folding the accumulated number of sheets received from the collect location to form a folded section;
a cam arrangement including a supplementary cam device for controlling the number of sheets collected at the collect location; and
an actuator for actuating the supplementary cam device.

2. The printing press as recited in claim 1 wherein the at least one printing unit is a digital printing unit.

3. The printing press as recited in claim 1 further comprising:
a transfer cylinder receiving sheets cut from the web, the transfer cylinder transferring the sheets to the collect cylinder.

4. The printing press as recited in claim 1 wherein the actuator is pneumatic, hydraulic or servo driven.

5. The printing press as recited in claim 1 further comprising a gripping device to hold leading edges of the sheets.

6. The printing press as recited in claim 5 wherein the gripping device includes pins, vacuum grippers or mechanical grippers.

7. The printing press as recited in claim 1 wherein the folded section is a complete product.

8. The printing press as recited in claim 1 wherein a second number of sheets are accumulated at a second collect location.

9. The printing press as recited in claim 8 wherein the second number of sheets are different from the first number of sheets.

10. The printing press as recited in claim 8 wherein the second number of sheets are identical to the first number of sheets.

11. The printing press as recited in claim 1 wherein the supplementary cam device includes a cam mask.

12. The printing press as recited in claim 1 wherein the supplementary cam device includes a further cam.

13. The printing press as recited in claim 1 wherein the supplementary cam device includes a clamp or support rod.

14. The printing press as recited in claim 1 further comprising a cam follower following the cam.

15. The printing press as recited in claim 14 wherein the supplementary cam device inhibits the cam follower from following the cam.

16. The printing press as recited in claim 1 further comprising a controller for controlling the actuator.

17. The printing press as recited in claim 1 wherein the number of sheets collected changes while the web is running

18. The printing press as recited in claim 1 wherein the folding cylinder is a jaw cylinder.

19. A method of forming a printed product comprising the steps of:
printing a running web with at least one printing unit;
cutting a web into sheets;
collecting a number of sheets on a collect cylinder at a collect location;
actuating a supplementary cam device to control the number of sheets collected at the collect location; and
folding the number of sheets received from the collect cylinder to form a section.

20. The method as recited in claim 19 wherein the at least one printing unit is a digital printing unit.

21. The method as recited in claim 19 wherein the supplementary cam device is actuated using a pneumatic, hydraulic or servo driven actuator.

22. The method as recited in claim 19 wherein the number of sheets includes a plurality of sheets collected on the collect cylinder at the collect location.

23. A method of forming a newspaper comprising the steps of:
forming a section as recited in claim 21; and
forming a second section from the same web; and
combining the section and second section to form a newspaper.

24. The method as recited in claim 23 wherein the section and second section have a different number of sheets.

25. The method as recited in claim 23 wherein the section and second section are consecutive newspaper sections.

26. A method of digitally printing a web and forming a printed product from the web comprising the steps of:
printing a web in a sequence with at least one digital printing unit;
cutting the web into a plurality of sheets;
collecting a first number of sheets on a collect cylinder at a first collect location;
collecting a second number of sheets on the collect cylinder; and
changing the number of sheets collected from the first number to the second number while the web is running

27. The method as recited in claim 26 further comprising the step of:
folding the first number of sheets off the first collect location to form a first section.

28. The method as recited in claim 27 wherein the step of folding includes tucking the collected first number of sheets into a jaw cylinder.

29. The method as recited in claim 26 further comprising the step of:
folding the second number of sheets off the collect cylinder to form a second section.

30. The method as recited in claim 29 further comprising the step of:
combining the first and second sections to form a multi-section printed product.

31. The method as recited in claim 29 wherein the sequence includes sheets from the first section and sheets from the second section.

32. The method as recited in claim 27 wherein the sequence includes multiples of sheets from the first section.

33. The method as recited in claim 26 further comprising the step of:
collecting the first number of sheets on the collect cylinder at a further collect location.

34. The method as recited in claim 26 further comprising the step of:
actuating a supplementary cam device to change the first number to the second number.

35. The method as recited in claim 26 further comprising the step of:
gripping the plurality of sheets on a transfer cylinder.
